(19) United States
(12) Patent Application Publication
(10) Pub. No.: US 2016/0085661 A1
(43) Pub. Date: Mar. 24, 2016

(54) Multi-Browser Testing For Web Applications

(71) Applicants: Antoine Clement, Paris (FR); Nicolas Lunet, Paris (FR); Gregory Micner, Noisy-le-Roi (FR); Richard Ly, Le Kremlin-Bicêtre (FR)

(72) Inventors: Antoine Clement, Paris (FR); Nicolas Lunet, Paris (FR); Gregory Micner, Noisy-le-Roi (FR); Richard Ly, Le Kremlin-Bicêtre (FR)

(21) Appl. No.: 14/514,830

(22) Filed: Oct. 15, 2014

Related U.S. Application Data
(60) Provisional application No. 62/052,398, filed on Sep. 18, 2014.

(51) Int. Cl. G06F 11/36; H04L 12/26; G06F 17/30; H04L 29/08

(52) U.S. Cl. CPC G06F 11/3664; H04L 67/02; H04L 43/50; G06F 17/30575

(57) ABSTRACT

In one aspect, there is an apparatus. The apparatus may include at least one processor, and at least one memory including computer program code. The at least one processor, the at least one memory, and the computer program code may be configured to cause the apparatus to perform operations including detecting, at a first synchronization application, an event representative of an action on a user element of a test web page. The operations may further include sending, by the first synchronization application, the detected event and an indication of the test web page to enable rendering of the test web page at a second device including a second synchronization application.

### CROSS REFERENCE TO RELATED APPLICATION

This application claims priority benefit to U.S. Provisional Patent Application Ser. No. 62/052,398, filed Sep. 18, 2014, and entitled “MULTI-BROWSER TESTING FOR WEB APPLICATIONS,” the contents of which are incorporated by reference in their entirety.

### FIELD

The subject matter described herein relates to testing web applications on multiple platforms and internet browsers.

### BACKGROUND

Information and services are increasingly being provided over the Internet. Services including email, online banking, online encyclopedias, and many others are now available via the Internet. These Internet based applications and information sources utilize web pages. Web developers have a need to test their web pages and applications. Because web pages and applications are accessed from many different computers and web browsers, the web pages and applications must be tested across a wide variety of fixed/mobile computers and web browsers that run on the computers.

### SUMMARY

In one aspect, there is an apparatus. The apparatus may include at least one processor, and at least one memory including computer program code. The at least one processor, the at least one memory, and the computer program code may be configured to cause the apparatus to perform operations including detecting, at a first synchronization application, an event representative of an action on a user element of a test web page. The operations may further include sending, by the first synchronization application, the detected event and an indication of the test web page to enable rendering of the test web page at a second device including a second synchronization application.

In some variations, one or more of the features disclosed herein including the following features can optionally be included in any feasible combination. The action may include at least one of a selection of a button on the test web page, a keyboard entry into the test web page, or an adjustment to a size of test web page. The second device including the second synchronization application may receive the detected event and the indication of the test web page. The second device may render, based on the received indication, the test web page. The second device including the second synchronization application may replicate the event representative of the action at a corresponding user element of the test web page rendered at the second device. The apparatus may monitor a result of the action.

The above-noted aspects and features may be implemented in systems, apparatuses, methods, and/or computer-readable media depending on the desired configuration. The details of one or more variations of the subject matter described herein are set forth in the accompanying drawings and the description below. Features and advantages of the subject matter described herein will be apparent from the description and drawings, and from the claims. In some exemplary implementations, one of more variations may be made as well as described in the detailed description below and/or as described in the following features.

### DESCRIPTION OF DRAWINGS

In the drawings,

FIG. 1 depicts a synchronizing server connected to master and slave computers, in accordance with some example implementations;

FIG. 2A depicts a process, in accordance with some example implementations;

FIG. 2B depicts another process, in accordance with some example implementations;

FIG. 2C depicts another process, in accordance with some example implementations;

FIG. 3 depicts examples of user interfaces of an application to synchronize web application testing, in accordance with some example implementations; and

FIG. 4 depicts additional examples of user interfaces of an application to synchronize web application testing, in accordance with some example implementations.

Like labels are used to refer to the same or similar items in the drawings.

### DETAILED DESCRIPTION

One way to test a web application and associated web pages across different computing devices and browsers is to separately test each combination of browser and computing device/computer. A test engineer might load a web page and test the web page on a first computer running a first web browser. The engineer may then test other browsers running on the first computer. For each browser, the test engineer would confirm that the web page displays and functions as expected. The engineer may then repeat the process for other computers.

In some example implementations, a synchronizing application may enable the testing of a web page on multiple computers at the same time. For example, the synchronizing application may allow a user to perform actions on a web page at one computer (e.g., a master computer) and see the results of the actions on the master computer, and perform the actions on a web page on one or more other computers at the same time (e.g., slave computers). For example, a user at master computer 120 may display a web page. The synchronizing application may cause the same web page to be displayed on the slave computer(s). A user may make a keyboard entry such as “Fred” to the master computer 120 which may also display the entry. The synchronizing application may cause “Fred” to also be entered at the slave computers which may display “Fred” on the web page. In another example, the user may make a selection or cause an action such as adjusting the screen size using a mouse at the master computer 120. The synchronizing application may cause the same action to be performed at the slave computers as is performed at the master computer. In this way, a user may test a web page on multiple slave computers at the same time the user is testing the master computer. This allows for more efficient testing of the web page because the user may perform actions on one computer and may see the results on several computers. The slave computers may run the same web browser or a different web browser from the master computer. Testing on multiple computers and/or browsers may be referred to as synchronous testing. In some example implementations, a synchronizing server may enable synchronous testing.

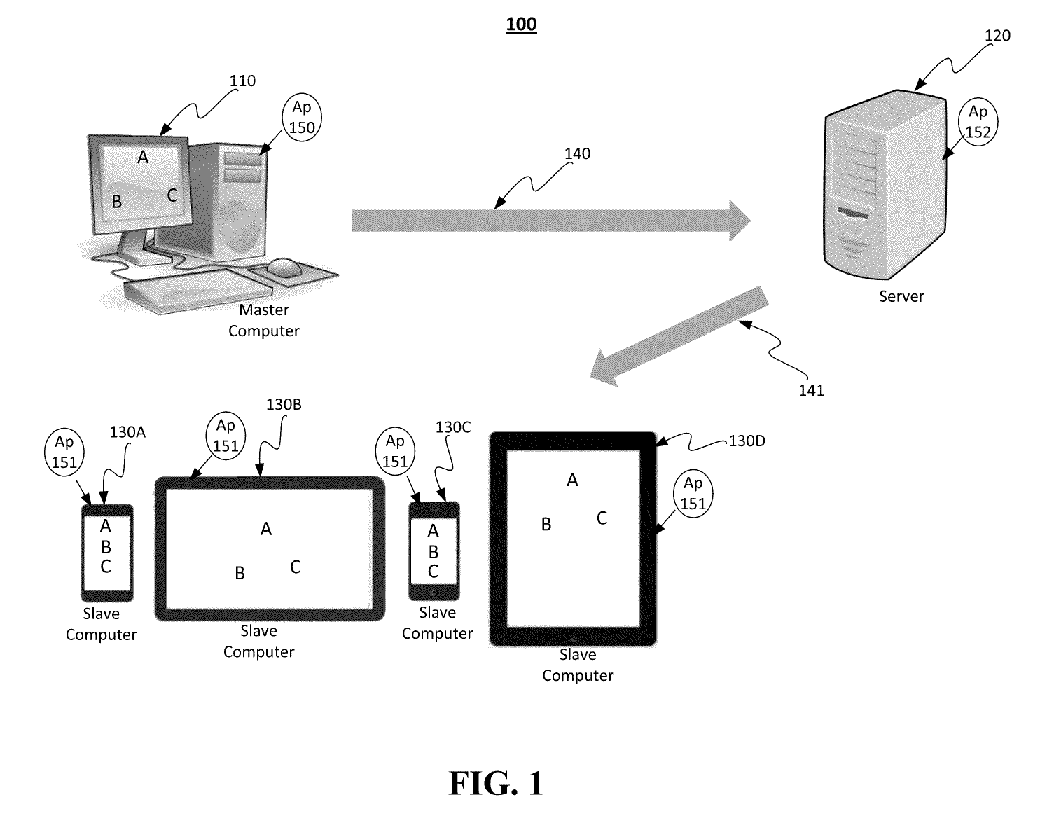

FIG. 1 depicts a synchronizing server connected to master and slave computers, in accordance with some example implementations. In some example implementations, there is provided a synchronizing server 120 that causes a series of actions performed on a web browser at a master computer 110 to also be performed on web browsers running on slave computers 130A, 130B, 130C, and 130D (also referred to herein as 130A-130D).

Master computer 110 may be connected through a network such as network 140 to server 120. In some example implementations, a web browser running on master computer 110 may access a target web page. Master computer 110 may run application 150 (also referred to as a synchronizing application) that sends the target web page to the server 120. Master computer 110 may also send one or more actions performed on the target web page at the master computer 110. For example, the actions may include user input at master computer 110 such as keyboard entry, mouse clicks or selections, or input from another user interface. In some example implementations, the master computer 110 may cause one or more slave computers to lockout local users of those computers to prevent interference with the actions from the master computer.

Slave computers, such as slave computers 130A-130D may be connected through a network such as network 141 to synchronizing server 120. Network 141 may be the same network as network 140, or may be a different network. Slave computers 130A-130D may be capable of running one or more web browsers. Slave computers 130A-130D may run synchronizing application 151 that interfaces with synchronizing server 120 and master computer 110. Slave computers 130A-130D may receive a target web page from master computer 110 through synchronizing server 120. The synchronizing application 151 running on slave computers 130A-130D may cause the actions to the target web page that are performed on master computer 110 and sent via synchronizing server 120 to slave computers 130A-130D to be performed on slave computers 130A-130D. FIG. 1 depicts four slave computers, 130A-130D, but any other quantity of slave computers may be used as well.

Synchronizing server 120 may receive the designated target web page from master computer 110 and may generate a session identifier corresponding to a session created by the connection of master computer 110 to the synchronizing server 120. In some example implementations, the session identifier my be chosen by a user at the master computer or chosen by the master computer. In some example implementations, the synchronizing server 120 may send the target web page and the session identifier to the slave computers such as slave computers 130A-130D. Synchronizing server 120 may cause web browsers on slave computers 130A-130D to open the target web page. Synchronizing server 120 may cause slave computers 130A-130D to use a browser selected at master computer 110. Synchronizing server 120 may send the actions performed at master computer 110 to slave computers 130A-130D. The synchronizing application 150 running on master computer 110, the synchronizing application 151 running on slaves 130A-130D, and the synchronizing application 152 may together cause the actions performed on the target web page at master computer 110 to be performed on target web pages at slave computers 130A-130D.

Master computer 110 and the plurality of slave computers such as slave computers 130A-130D may include any combination of computers including desktop computers, laptops, notebook computers, netbooks, tablets, smart phones, and/or cell phones, and any other type of computing apparatus. The master computer and slave computers may run any combination of browsers such as Microsoft Internet Explorer®, Fire Fox®, Safari®, and/or any other type of web browser. The master computer and plurality of slave computers may be capable of running more than one web browser. In some example implementations, the master computer 110 and the synchronization server 120 may be combined into one piece of equipment.

For example, the master computer 110 may be an Apple desktop computer running Safari®. In this example, the plurality of slave computers 130A-130D may include an Android® smartphone running a Fire Fox® browser, an Apple iPad running Safari®, a tablet computer running Microsoft Internet Explorer®, and a netbook running a proprietary browser. A synchronization application may run on the master computer 110, the slave computers 130A-130D, and synchronization server 120. The synchronization applications 150, 151, 152 and the synchronizing server 120 may cause actions taken by a user at the master computer's web browser to be actions taken by the web browsers of the slaves 130A-130D. In this way, an engineer, or observer, can test a web page on multiple computers and browsers at the same time. The actions performed by the engineer or observer may be displayed on the slave computers at the same time as the master computer or nearly the same time. The observer may see the effect of her actions at the master by looking at the slaves to see the results of the actions without re-running the test for the different computers and/or browsers.

In some example implementations, a synchronizing server 120 may connect to two or more other computers. One of the other computers may be designated a master 110 and the other computers designated as slave computers. The slave computers may receive from the synchronizing server 120 the session identifier and the target web page. In some example implementations, the slave computers may receive a uniform resource locator (URL) for the target web page from the synchronizing server.

In some example embodiments, a remote computer (not shown in FIG. 1) may connect to the synchronizing server to control master computer 110, server 120, and slave computers 130A-130D through a web browser at the remote computer. For example, the remote computer may connect to the synchronizing server by accessing a predefined URL corresponding to the server. Through the web browser, the remote computer may trigger an action at the master computer 110 such as viewing the connected slave computers, locking one or more slave computers, starting a recording of actions performed at the master, and/or playing back a recording of actions performed at the master.

In some example implementations, one or more of the slave computers such as slave computer 130A may send a message to master computer 110 including information about the execution of one or more actions. The information may include an indication about whether the action was successful at the slave computer. The message may be sent from synchronizing application 151 to synchronizing application 150. In some example implementations the message may pass from 151 to 152 to 150. In some example embodiments, a slave computer may include in the message information relating to results from the action being executed at the web browser at the slave computer 130A. In some example implementations, a screen shot of the web browser at the slave 130A may be included in the message to master 110. In this way, a user at the master computer 110 may observe the results of actions on the web browsers of the slave computers from the master computer's screen.

In some example implementations, the synchronizing applications at the master computer 110 and slave computers 130A-130D may be implemented as a script, such as a script written for JavaScript®, although other types of scripts can be used. The scripts may be passed through a network and/or the Internet from the synchronizing server 120 to the master computer and slave computers 130A-130D. In some example implementations, the synchronizing application may be downloaded and initiated over the Internet. In addition to the synchronizing application, only JavaScript may be needed to perform synchronous testing of a web application. In some example implementations, a first JavaScript® script is run on the slave computers and a second JavaScript Script® is run on the master computer, and a third JavaScript® script may be run on the synchronizing server. In some example implementations, one script may include the executable instructions to perform as a master, a slave, and as a synchronizing server. In some example implementations, the synchronizing applications 150, 151 may be installed at a runtime. Any other programming language may be used in the synchronizing applications 150, 151, 152 instead of JavaScript® or in addition to JavaScript®.

In some example implementations, the master computer may cause actions to be performed at one or more slave computers without a synchronizing server. For example, the master computer may connect to multiple slave computers through a wired or wireless network without a synchronizing server. The master computer may designate a target web page and through the synchronizing application cause the browsers running on the slave computers to perform the same actions that are performed on the web browser at the master computer.

In some example implementations, inputs to a web page may be recorded and later played back to control a web page at one or more browsers on slave computers, such as slave computers 130A-130D. For example, actions performed at a web browser running at a master computer 110 may be recorded by the synchronizing application 150 at master computer 110. The recorded actions may then be played back at any time to cause the recorded actions to be performed on a web page at one or more slave computers. The slave computers and the master computer may be connected together by a network and a synchronizing server may be present.

In some example implementations, a user or teacher at a master computer may receive a web page from another user or student at a slave computer. For example, a user of the slave computer, such as a student, may be having trouble using a web page. The student may send the problem web page or a URL for the web page to a teacher at the master computer. The teacher may retrieve the problem web page and designate the problem web page as the target web page to the synchronizing server. The student may then connect to the synchronizing server as a slave computer with the teacher as the master. The teacher (master computer) may then assist the student (slave computer) in navigating the problem web page. Both the student (slave) and the teacher (master) will see the same web page and the results of the teacher's inputs to the web page and navigation of the web page.

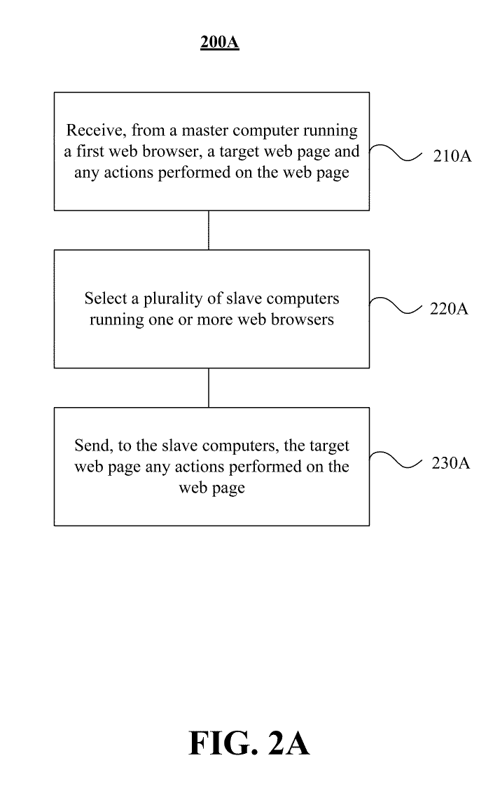

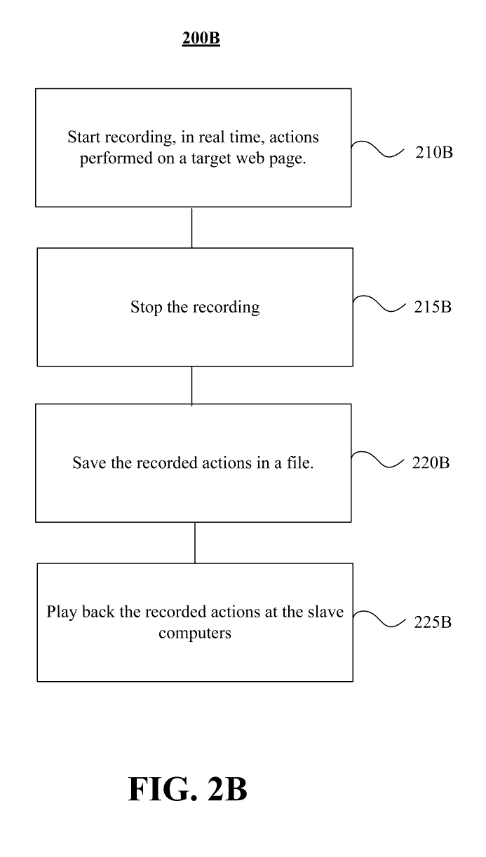

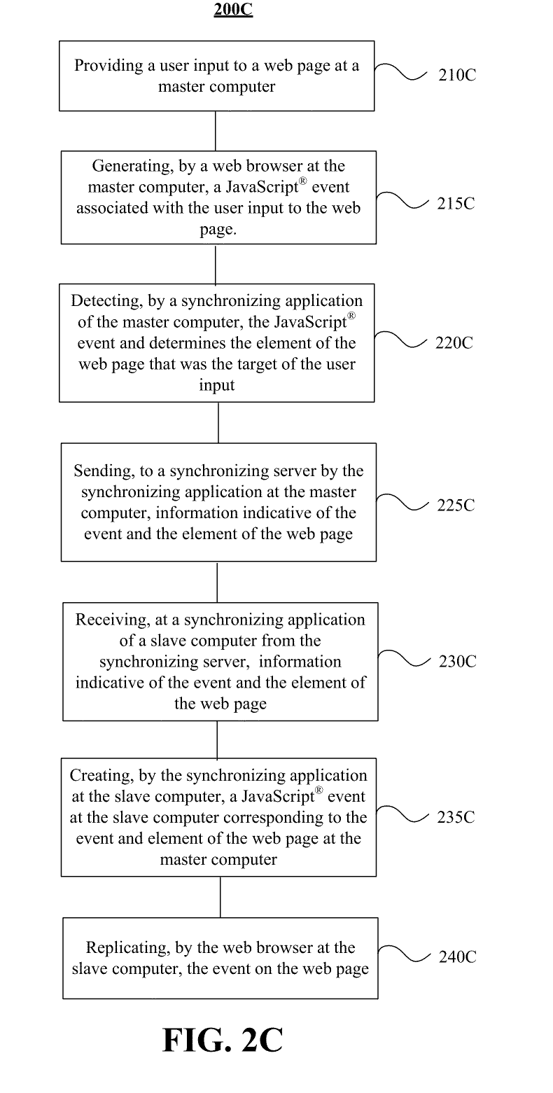

FIG. 2A depicts a process 200A, in accordance with some example implementations. At 210A, a synchronizing server may receive a web page from a master computer. At 220A, the synchronization server may connect to a plurality of slave computers. At 230A, the slave computers may be caused to display the target web page and perform the same actions at the slave computer's web browsers as the actions performed at the master computer's web browser. The description of FIG. 2A also refers to FIG. 1.

At 210A, a synchronizing server such as synchronizing server 120 may receive a target web page from a master computer such as master computer 110. For example, a master computer 110 that is a Windows desktop computer running Google Chrome® may select a target web page. In some example implementations, the selection and sending of the target web page to the synchronizing server 120 may be performed by a synchronizing application 150 running with the web browser on the master computer 110. In this example, the synchronizing application may run in conjunction with Google Chrome®. The synchronizing server may also run a JavaScript® script and a web browser. The synchronizing application at the master computer 110 may send the target web page (or URL) to the JavaScript® script running on the synchronization server 120.

At 220A, the synchronization server such as synchronizing server 120 may connect to a plurality of slave computers. In some example implementations, the synchronization server may connect to slave computers in accordance with a selection of slave computers made by a user at master computer 110. The synchronizing application 150 running on the master computer may cause communication of the selection of slave computers from the master computer 110 to the synchronizing server 120. In some example implementations, the synchronization server 120 may establish connections with slave computers such as slave computers 130A-130D in accordance with the selection.

At 230A, the slave computers may be caused to display the target web page. For example, the slave computers may be caused through the synchronization server 120 and the synchronizing application 151 running on the slaves 130A-130D to display the target web page. In some example implementations, the slave computers perform the same actions at the slave computer's web browsers as the actions performed at the master computer's web browser. For example, as a user navigates or makes data entry to the web page at the master computer, each of the slaves may be caused to perform the same navigation and make the same data entries as the master computer. In some example implementations, the web browser used by one or more slaves may be selected by the master computer and activated at the slave computers through the synchronizing application and synchronizing server.

FIG. 2B depicts another process 200B, in accordance with some example implementations. At 210B, a synchronization application may start recording the actions performed at a web browser on a web page. At 215B, the synchronization application may stop the recording. At 220B, the actions performed at the web browser on the web page may be saved in a file. The saved file may be played back later to cause the recorded actions to be performed on the same or different computer and/or web browser. The description of FIG. 2B also refers to FIG. 1.

At 210B, a synchronization application may record actions performed at a web browser on a web application or web page. For example, a user may navigate to a target web page with the target web page displayed on a web browser at a master computer such as master computer 110. The user may cause the synchronization application to start recording the actions taken by the user. The recorded actions may include navigation performed by the user such as adjusting the display of the web page by zooming, scrolling, or other navigation action. The recording may also include inputs made by the user such as keyboard inputs or inputs from a pointing device such as a mouse. The recording may also include timing information. For example, the recording may include the time delays between the user's inputs and actions. In some example implementations, one or more of the actions and/or inputs to the target web page may not come from a user but instead from another source such as another web application, or other application or source.

At 215B, the synchronization application may stop recording. For example, a user may cause the synchronization application to stop recording the actions taken on the target web page by the user. At 220B, the recorded actions may be saved in a file. For example, the recorded actions may be saved in a text file or other file format. The saved file may be played back at a later time to repeat the actions performed by the user or other application with the same or nearly the same delays between actions. In some example implementations, the delays between actions may be increased or decreased. For example, the actions may be played back more quickly (reduced delays) or more slowly (increased delays) than the original recording. Replying the recording may cause the same actions to be performed on the same or different computer and/or web browser. For example, the recoded actions may be played back using the same computer running a different web browser than the browser used to make the recording. In some example implementations, the recorded actions may be played back using the same browser as was used to make the recording but on a different computer. In some example implementations, the recorded actions may be played back using a different browser running on a different computer. In some example implementations, the recorded actions may be played back on multiple computers and browsers (slave computers) at the same time, or nearly the same time. In some example implementations, a saved recording may be played back at a synchronizing server to browsers running on a plurality of slave computers.

FIG. 2C depicts another process 200C, in accordance with some example implementations. At 210C, a user input may be provided to a web page at a master computer. At 215C, a JavaScript® event may be generated that is associated with the user input to the web page. At 220C, a synchronizing application may detect the JavaScript® event. At 225C, information indicative of the event and the web page may be sent to a synchronizing server. At 230C, the information may be sent from the synchronizing server to slave computers via a synchronizing application running on the slave computers. At 235C, a JavaScript® event may be generated at the slave computers by the synchronizing application at the slave computers. At 240C, the event may be duplicated on the web page by web browsers at the slave computers. The description of FIG. 2C also refers to FIG. 1.

At 210C, a user input may be provided to a web page at a master computer. For example, a user may make a keyboard entry to the web page, or use a mouse to make a selection on the web page via a mouse click. In another example, the user may adjust an aspect of the web page display such as the size of the web page on the screen. The user input may also include any other type of input to a web page as well.

At 215C, a JavaScript® event may be generated that is associated with the user input to the web page. For example, a keyboard entry by a user, a button being clicked by the user, or other action taken at the web browser of the master computer may generate a JavaScript® event.

At 220C, a synchronizing application may detect the JavaScript® event. For example, a synchronizing application running at the master computer such as master computer 110 may detect the JavaScript® event that was generated by the web browser due to the user's input.

At 225C, information indicative of the event and the web page may be sent to a synchronizing server. For example, the information and the web page may be sent to synchronizing server 120 by master computer 110. In some example embodiments, multiple events may be sent. The event information may include JavaScript® event information. The web page information may include a uniform resource locator for the web page.

At 230C, the information indicative of the event may be sent from the synchronizing server to one or more slave computers via a synchronizing application running on the slave computers. For example, the JavaScript® event information may be sent from synchronizing server 120 to slave computers such as slave computers 130A-130D via a synchronizing application running on slave computers 130A-130D. Synchronizing server 120 may also run a synchronizing application that is the same or different from the synchronizing applications of the slave computers and master computer.

At 235C, a JavaScript® event may be generated at the slave computers by the synchronizing application at the slave computers. For example, a JavaScript® event for the web browsers of slaves 130A-130D may be generated by the synchronizing application running at each slave computer. The JavaScript® event may correspond to the event that was generated at the master computer 110 and detected by the synchronizing application at the master computer 110.

At 240C, the event is duplicated on the web page of each slave computer by the web browser at each slave computer. For example, the JavaScript® event generated by the synchronizing application at a slave computer may be performed at the web browser of the slave computer.

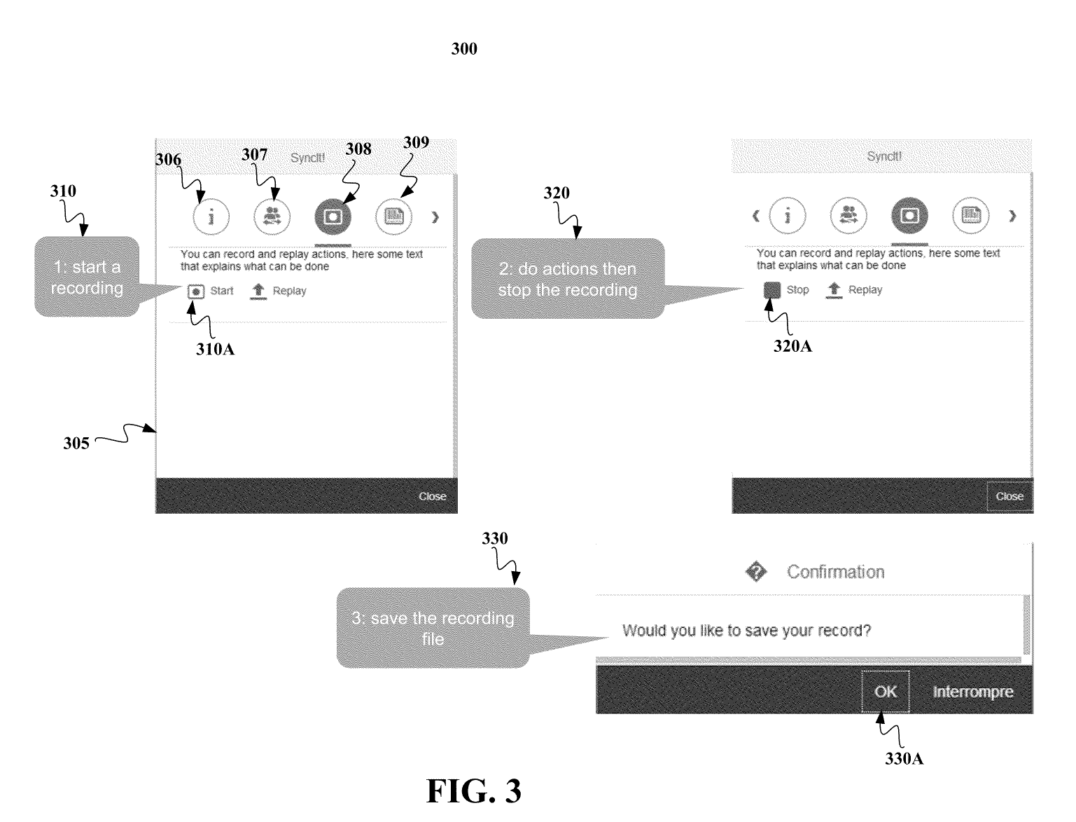

FIG. 3 depicts screenshots from a user interface for the synchronization application, in accordance with some example implementations. At 310A, a recording of the actions performed on a target web page may be started. At 320A, the recording of actions may be stopped. At 330A, the recorded actions may be saved in a file. The description of FIG. 3 also refers to FIGS. 1, 2A, and 2B.

At 305, a user interface for a synchronizing application is shown, in accordance with some example implementations. The user interface button 306 may cause a window to open showing a session identifier corresponding to the connection between a master computer such as master computer 110 and a synchronizing server such as synchronizing server 120. The user interface button 307 may cause a window to open showing a list of slave computers connected to the synchronizing server, and a button inside the window to synchronize the connected slave computers to the master computers target web page. An internet protocol address may be associated with each slave computer. The slave computers may be controlled by the master computer through the synchronizing server or by replaying recorded actions via a file as detailed above in FIGS. 1, 2A, and 2B.

When the user interface button 308 is selected, widow 305 may open. At 310, a user may start recording at master computer 110 the actions being performed on a target web page by selecting “start” at 310A. The user may next navigate the web page and perform actions including providing input from a keyboard as detailed above. The actions may be recorded as described with respect to FIGS. 1 and 2B. The user may stop the recording at 320 by selection “stop” at 320A. The recording may be stored in a file at 330 by selecting to save the record at 330A. In some example implementations, a file name may be specified by the user.

The user interface button 309 may cause a window to open showing a quick response (QR) code. The quick response code may be representative of information including a uniform resource locator for the synchronization server. The quick response code may also include a session identifier and a target web page uniform resource locator. The quick response code may be used by a slave computer or other computer to connect to the synchronization server and join the session. For example, the quick response code may cause a computer to be listed as a slave computer in window 307 detailed above. In some example implementations, a master computer such as master computer 110 may send the quick response code to other computers to enable the other computers to become slave computers in a session between a master computer and a synchronization server.

In some example implementations, a link may be provided to the slave computers that includes the information in the quick response code to a slave computer. In some example implementations, a slave computer may connect by navigating to a web address and entering a session identifier.

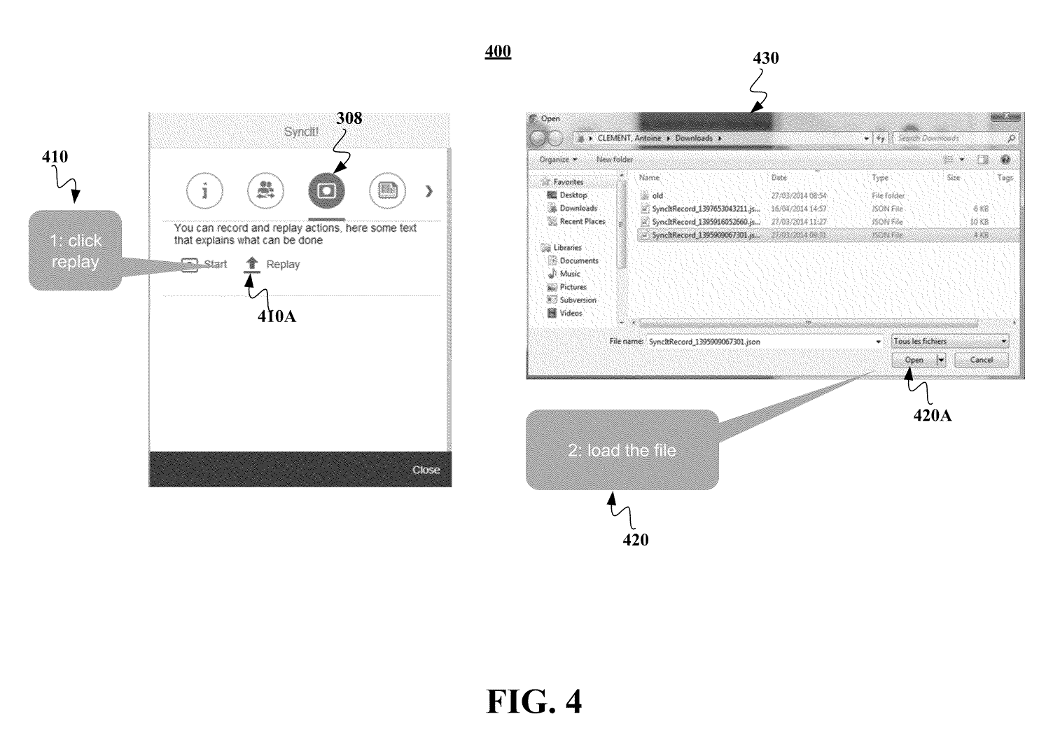

FIG. 4 depicts an additional user interface for a synchronization application, in accordance with some example implementations. The description of FIG. 4 also refers to FIG. 3. At 410 a user may select to replay 410A previously, recorded actions saved to a file. At 420, the user may select which file to load 420A from a file selection dialog box 430. The loaded file may be replayed to the slave computers or clients described above with respect to FIG. 3 at 307.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other implementations may be within the scope of the following claims.

What is claimed:

1. An method comprising:
detecting, at a first device including a first synchronization application, an event representative of an action on a user element of a test web page; and
sending, by the first device including the first synchronization application, the detected event and an indication of the test web page to enable rendering of the test web page at a second device including a second synchronization application.

2. The method of claim 1, wherein the action comprises at least one of a selection of a button on the test web page, a keyboard entry into the test web page, or an adjustment to a size of test web page.

3. The method of claim 1, further comprising:
receiving, at the second device including the second synchronization application, the detected event and the indication of the test web page.

4. The method of claim 1, further comprising:
rendering, based on the received indication, the test web page at the second device.

5. The method of claim 1, further comprising:
replicating, at the second device including the second synchronization application, the event representative of the action at a corresponding user element of the test web page rendered at the second device.

6. The method of claim 1, further comprising:
monitoring a result of the action.

7. An apparatus comprising:
at least one processor; and
at least one memory including computer program code, the at least one processor, the at least one memory, and the computer program code configured to cause the apparatus to perform operations comprising:
detecting, at a first synchronization application, an event representative of an action on a user element of a test web page; and
sending, by the first synchronization application, the detected event and an indication of the test web page to enable rendering of the test web page at a second device including a second synchronization application.

8. The apparatus of claim 7, wherein the action comprises at least one of a selection of a button on the test web page, a keyboard entry into the test web page, or an adjustment to a size of test web page.

9. The apparatus of claim 7, further comprising:
receiving, at the second device including the second synchronization application, the detected event and the indication of the test web page.

10. The apparatus of claim 7, further comprising:
rendering, based on the received indication, the test web page at the second device.

11. The apparatus of claim 7, further comprising:
replicating, at the second device including the second synchronization application, the event representative of the action at a corresponding user element of the test web page rendered at the second device.

12. The apparatus of claim 7, further comprising:
monitoring a result of the action.

13. A non-transitory computer-readable medium encoded with instructions that, when executed by at least one processor, cause operations comprising:
detecting, at a first synchronization application, an event representative of an action on a user element of a test web page; and
sending, by the first synchronization application, the detected event and an indication of the test web page to enable rendering of the test web page at a second device including a second synchronization application.

14. The non-transitory computer-readable medium of claim 13, wherein the action comprises at least one of a selection of a button on the test web page, a keyboard entry into the test web page, or an adjustment to a size of test web page.

15. The non-transitory computer-readable medium of claim 13, further causing operations comprising:
receiving, at the second device including the second synchronization application, the detected event and the indication of the test web page.

16. The non-transitory computer-readable medium of claim 13, further causing operations comprising:
rendering, based on the received indication, the test web page at the second device.

17. The non-transitory computer-readable medium of claim 13, further causing operations comprising:
replicating, at the second device including the second synchronization application, the event representative of the action at a corresponding user element of the test web page rendered at the second device.

18. The non-transitory computer-readable medium of claim 13, further causing operations comprising:
monitoring a result of the action.
